(19) United States
(12) Patent Application Publication
(10) Pub. No.: US 2009/0159803 A1
(43) Pub. Date: Jun. 25, 2009

(54) APPARATUS FOR SELECTED MEASUREMENT OF, IN PARTICULAR LUMINESCENT AND/OR FLUORESCENT RADIATION

(75) Inventors: Fritz BERTHOLD, Pforzheim (DE); Norbert Klaiber, Enzkloesterle (DE)

Correspondence Address: BROWDY AND NEIMARK, P.L.L.C.;624 NINTH STREET, NW, SUITE 300, WASHINGTON, DC, 20001-5303, US

(73) Assignee: BERTHOLD TECHNOLOGIES GmbH & Co.KG, Bad Wildbad (DE)

(21) Appl. No.: 12/341,573

(22) Filed: Dec. 22, 2008

(30) Foreign Application Priority Data
Dec. 21, 2007 (DE) 202007017895.6
Jul. 23, 2008 (DE) 202008009859.9

(51) Int. Cl. G01T 1/20

(52) U.S. Cl. 250/363.01; 250/368

(57) ABSTRACT

An apparatus for selected measurement of at least one of luminescent and fluorescent radiation from at least one sample well, the apparatus comprising: means defining an excitation light path for fluorescence measurements; at least one light source in the excitation path; means defining an emission light path; and at least one detector with a wavelength selector in the emission light path, wherein: the apparatus further comprises at least one first reflector element that encompasses a reflection chamber and projects at least a portion of the light emitted from the at least one sample well directionally onto the wavelength selector; the emission light path extends between the at least one sample well and the wavelength selector through the at least one first reflector element; and the excitation light path extends into the reflection chamber and extends to a point above the at least one sample well.

### BACKGROUND OF THE INVENTION

1. Technical Background

In the course of decreasing budgets and difficult cost structure in research, a number of manufacturers of microplate instruments haven gone over to instruments with multiple applications. The goal is to make a multipurpose instrument available to the customer for as many applications as possible, thus eliminating the need to purchase multiple individual instruments. Despite their higher price, compared to a dedicated instrument, these multipurpose instruments are enjoying strong demand. The customer is given the impression that the one purchase makes the purchase of individual instruments superfluous, and that the price of the multipurpose instrument is less than the sum for the dedicated instruments. At present, there are many different instruments, ranging from the “dual-label” instrument for luminescence and fluorescence measurements in the lowest category, through “multi-label readers” with fluorescence, luminescence and photometry in the middle price range, to the “high end” instruments for luminescence, fluorescence, photometry, fluorescence polarization, Bioluminescence Resonance Energy Transfer (BRET), Fluorescence Resonance Energy Transfer (FRET), Time-Resolved Fluorescence (TRF), Liquid Scintillation Counting (LSC), in a whole variety of combinations.

Unfortunately, in designing such multipurpose instruments for the desired types of measurements, so many compromises must be made that in the end the performance of the individual functions is markedly below that of the single instrument.

The main problem with the varying quality of the functions of a multipurpose instrument lies in the different requirements of the various measuring techniques.

For fluorescence measurements, it is essential that the sample be projected onto the detector and that the light be passed parallel through the filters-a process in which crosstalk occurs only to a small degree since the excitation is local.

The efficiency of the light transmission from the sample to the detector (emission light path) also only plays a subordinate role in fluorescence measurements (as opposed to luminescence measurements) since the fluorophores are excited with adequate amounts of light.

In luminescence measurements (bioluminescence or chemiluminescence), on the other hand, in which the photons are produced by a chemical reaction, their number is markedly limited. These systems must be optimized to the “collection” of all present photons and to their “detection.” These systems normally comprise optical systems, e.g. optical fibers, that pick up the photons directly from the samples and carry them on to the detector.

Difficulties exist with time-resolved fluorescence (TRF) measurements. Here, a flash of light is used for the excitation, a short amount of time is allowed to pass, and then the “time-delayed fluorescence” is measured. In other words, one excites with high energy and then measures only the specific fluorescence and no background fluorescence from the sample or from the materials that are used for the optical path. Nearly all materials, in particular plastics, have a phosphorescence that contributes to the background signal.

To measure the above-mentioned BRET, a filter is required upstream of the detector, and most manufacturers use their fluorometers for BRET. The photon emission is triggered by a chemical reaction (luminescence) however, and therefore only a small number of photons are present. The sensitivity of fluorometers is, therefore, not adequate.

The excitation light path for fluorescence measurements starts with a light source, e.g. that of a halogen lamp or xenon flash lamp; suitable optical components carry the light in sufficient intensity and positional accuracy to the sample.

The excitation light path contains at least one optical filter, so that only excitation light falls, in a usually narrowly limited wavelength range, onto the sample.

In the emission light path, the fluorescent light that is generated in the sample is carried to the detector, where it is measured. In-between, an optical filter is positioned at a suitable location as an emission filter.

As a rule, it is possible with this design of a fluorescence measuring path to switch off the excitation light source and to then also measure luminescence. A serious shortcoming of such a configuration, which is used in some multi-label readers, however, is its low sensitivity in luminescence measurements, since only a small percentage of the photons that are emitted by the sample falls onto the lens in the emission light path and can therefore reach the detector. A configuration of this type is less sensitive by approximately one order of magnitude than a well-constructed luminometer.

2. Prior Art

From European Patent Disclosure EP 0 803 724 A2 a multi-label measuring instrument is known that fails to overcome the above-mentioned problems, primarily because its displaceable mirror block that is designed for all of the measurements does not allow for a highly efficient light passage for detecting weak luminescence signals. The spatial angle of the light emitted by the sample that is detected by the lens is small, so that only a small number of the photons originally emitted reaches the detector. Moreover, in this configuration, crosstalk of samples in adjacent sample wells of the microplate is high. This leads to incorrect measurement results if a strongly light-emitting sample located next to a weakly light-emitting sample emits so much light that too high a value is measured at the weakly light-emitting sample.

In European Patent Disclosure EP 1 279 946 A1, a configuration is described that provides independent optical emission light paths for the individual measuring techniques, namely fluorescence and luminescence in particular, so as to prevent these shortcomings.

The emission light path for luminescence measurements in this case substantially consists of a block of single optical fibers that are routed parallel to each other and glued to each other; the excitation light path and the emission light path for fluorescence measurements correspond to the one discussed at the beginning. The light in the excitation light path in this optical system falls onto the sample as a convergent light beam.

The detector and the fluorescence-exciting radiation source are movable and are moved by a motor into the position required for the respective measurement. The measuring position of the sample wells within the instrument for the different types of measurements is therefore not fixed but determined by the measuring technique.

If reagent injection into the measuring position is required, injection positions may possibly need to be provided at each optical path.

It is indeed possible to attain good sensitivity values with this configuration, especially for luminescence measurements. However, the constructional expenses are much higher compared to an embodiment with only a single optical emission light path, particularly if multiple paths must each be provided with their own injectors. Additional expenses are caused also by the transport mechanism for the detector, and the frequent movements of the highly sensitive detector also carry the risk of damage. Moreover, this configuration requires that the light source in the excitation path must be movable as well.

In U.S. Pat. No. 6,891,681 B2, a measuring instrument is described in which an optical fiber is used to carry the excitation light through an aperture into the module, where it falls onto a dichroic mirror that directs the light onto the sample via two lenses that are positioned outside the module. The fluorescent light that is generated in the sample is directed back via the two lenses onto the dichroic mirror, through which the longer-wavelength light passes and reaches a dichroic beam splitter. The same splits the light into two wavelength ranges. Each of the two partial beams that are created in this manner leaves the module through an additional aperture in each case, in order to ultimately be measured separately via two filters and corresponding lenses in two detectors.

In the first place, this optical system has the crucial shortcoming that the two dichroic mirrors or beam splitters are impinged upon only by either convergent or divergent light beams, whereas the best performance is attained only with parallel, or collimated, light incidence.

Another significant shortcoming of this optical system is that it is not suitable for the sensitive measurement of chemiluminescence. These measurements require an optional detector that receives the light via an optical fiber directly from the sample. Even then it is apparently not possible to inject reagents into the measuring position; nor is it possible in this configuration to perform chemiluminescence measurements with filters, such as BRET or Chroma-Glow.

From these examples it becomes apparent that the demands placed on a multi-label measuring system, in order to operate optimally, are quite manifold. For reasons of optics, geometric dimensions, availability of lenses with special materials and certain refraction indices, compromises had to be made, if a more or less common optical path is to be used, that led to a reduced performance compared with special instruments, or increased work and expenditures were needed to establish individual measuring light paths that were optimized for the respective measuring method.

### BRIEF SUMMARY OF THE INVENTION

It is an object of the invention to attain with only one common (emission) light path for both fluorescence and luminescence at least the same sensitivity as with specialized fluorometers and luminometers.

This object is met according to the invention by an apparatus for selected measurement of, in particular, luminescent and or fluorescent radiation from at least one sample well by means of at least one light source in the excitation light path for fluorescence measurements and at least one detector with a wavelength selector in the emission light path, wherein the emission light path is guided between the at least one sample well and said wavelength selector through at least one first reflector element that encompasses a reflection chamber and projects at least a portion of the light emitted from the sample well directionally onto said wavelength selector, and the excitation light path in the reflection chamber is guided to a point above the sample well.

An underlying concept of the invention is that the optical coupling of the sample well to the detector takes place via a first reflector element provided with a mirrored inner surface that forms a reflection chamber that effects a directional alignment of the light exiting from the surface of the sample well. This bundling may, in dependence upon the utilized wavelength selector, be a substantially parallel orientation of the emitted photons, but it may also incorporate a convergence effect such that a concentration of the photons takes place onto a defined surface area in the plane of said wavelength selector.

Significant advantages of the common emission light path lie in that a single stationary detector for fluorescence and luminescence measurements and a stationary light source can be used.

In a preferred embodiment said wavelength selector is formed by an emission filter. In this case the mirrored interior surface of the reflection chamber is implemented in the shape of a frustum of a paraboloid of revolution. Its focal point lies within or in the near vicinity of the sample well.

This achieves that the light that is emitted from the sample well leaves the reflection chamber largely collimated and is incident perpendicularly on the emission filter. This is advantageous since the action of the filter, particularly of interference filters, is best at a perpendicular beam passage.

In practice, the paraboloid section can also be approximated by means of stacked cone frustum sections.

In an additional preferred embodiment the excitation light path contains a reflector element in the form of a deflecting mirror that projects the excitation light substantially perpendicularly onto the surface of the sample.

This deflecting mirror, in turn, is preferably supported in a light-impermeable tube in which the excitation light is carried in the excitation light path. The deflecting mirror is disposed on a light-impermeable base and divides the light-impermeable tube into two sections—a horizontal section for carrying the excitation light into the reflection chamber to the deflecting mirror, and a vertical section adjoining the deflecting mirror for carrying the deflected excitation light onto the sample well.

The continuous light-impermeable passage of the excitation light inside the reflection chamber prevents the excitation light from traveling directly to the detector, where it could lead to distortions of the measurement.

An additional advantageous embodiment provides, for the same reason, that the components for carrying the excitation light inside the reflection chamber are made light-absorbing on their outside.

Disposed in the beam path of the excitation light path is a focusing lens whose focal point is selected such that it preferably lies below the focal point of the paraboloid; surprisingly, it is possible with this constellation to achieve a maximization of the light gain.

A further advantageous embodiment relates to the constructional implementation of the guiding of the emission light. Here the emission filter and the detector have disposed between them an absorption surface in the form of a hollow cylinder, through which there can be achieved an elimination of undesirable portions of the emission light beam that must not reach the detector.

By means of a suitable selection of the dimensioning of the paraboloid section (or of the corresponding cone frustums) and light-carrying components in the region of the reflection chamber, an optimization of the inventive measuring apparatus can be attained in terms of its use as a multi-label measuring instrument, to the degree that an approximately ten times higher detection sensitivity for luminescence, as compared to fluorescence measurements in the luminescence path of the mentioned instrument, is attained over the multi-label instrument according to European Patent Disclosure EP 1 279 946 A1.

For fluorescence measurements as well, a signal strength is measured that, due to the high optical efficiency in the emission light path, is approximately ten times greater than in the mentioned instrument. However, the Null effect increases as well, so that the detection sensitivity, e.g. for FITC measurements, according to the 3 Sigma criterion, is even higher by over 100%.

In special adaptations of the fluorescence measurement technique, which will be described further below, the high optical efficiency that is attainable with the inventive apparatus has a greater impact.

In BRET measurements one achieves good spectral separation because of the parallel incidence of the emission light onto the emission filter that is implied in the inventive apparatus. Additionally, this collimation of the emission light makes use of a lens superfluous.

Because of the high optical efficiency of the reflection chamber, chemiluminescence can be measured with the same optical system and same detector as in fluorescence measurements, and with the highest sensitivity at that.

Injection of reagents into the measuring position is possible; furthermore, wavelength-dependent chemiluminescence measurements can be performed by introducing filters into the optical path.

Especially if the reflection chamber of the first reflector element is formed as a paraboloid, causing the light that exits from the reflection chamber to be oriented substantially parallel, an additional preferred embodiment of the invention has a spacer between the exit opening of the reflector element and the entrance window of the detector, so that modules with different optical properties can be used between the exit opening of the reflector element and the entrance window of the detector. This creates a modular design that facilitates efficient work in laboratory operations.

Especially for measuring BRET, FRET, or TR-FRET, it can be advantageous to measure the light intensity in two wavelength ranges simultaneously with two detectors and with the use of different emission filters. In an additional preferred embodiment two detectors are, therefore, provided above the reflector element, whose optical axes (which are the surface normals of the entrance windows) are positioned obliquely to the surfaces of the liquid samples contained in the sample wells. This creates a reflection chamber with two sections, which may be referred to as partial reflection chambers. These partial reflection chambers are preferably paraboloidal in shape.

Additional preferred embodiments will become apparent from the exemplary embodiments that will now bedescribed in detail with reference to the figures.

### BRIEF DESCRIPTION OF THE DRAWINGS

Exemplary embodiments of the inventive measuring apparatus will be described in detail in conjunction with drawings, in which:

FIG. 1 shows a perspective sectional view of the measuring apparatus.

FIG. 2 shows a perspective overview of the measuring apparatus according to FIG. 1 without sample well, with injection device and laser module.

FIG. 3 shows a schematic illustration of the excitation light path in fluorescence measurements.

FIG. 4 shows an illustration of the correspondence between the optical proportionalities of the two reflector elements.

FIG. 5 shows a perspective sectional view of the guide components of the excitation light in the reflection chamber.

FIGS. 6A, B and C show schematic views of light beams of the emission light path in the reflection chamber.

FIGS. 7 and 8 show sectional views through the measuring apparatus with an injection element for luminescence measurements and laser module.

FIG. 9A shows a schematic view of an embodiment of the measuring apparatus for fluorescence polarization measurements.

FIG. 9B is a detail plan view of a portion of the embodiment of FIG. 9A.

FIG. 10 shows a partial sectional view of an embodiment of the measuring apparatus for fluorescence measurements from below.

FIG. 11 shows a sectional view of a measuring apparatus with multiple modules.

FIG. 12 shows a first module in a sectional view.

FIG. 13 shows a second module in a sectional view.

FIG. 14 shows an additional embodiment of the invention in a sectional view.

FIG. 15 shows an additional embodiment of the invention in a sectional view.

FIG. 16 shows a variation of the embodiment of FIG. 14.

FIG. 17 shows an embodiment of the invention with two detectors.

FIG. 17B is a detail view of a portion of the embodiment of FIG. 17.

### DETAILED DESCRIPTION OF THE INVENTION

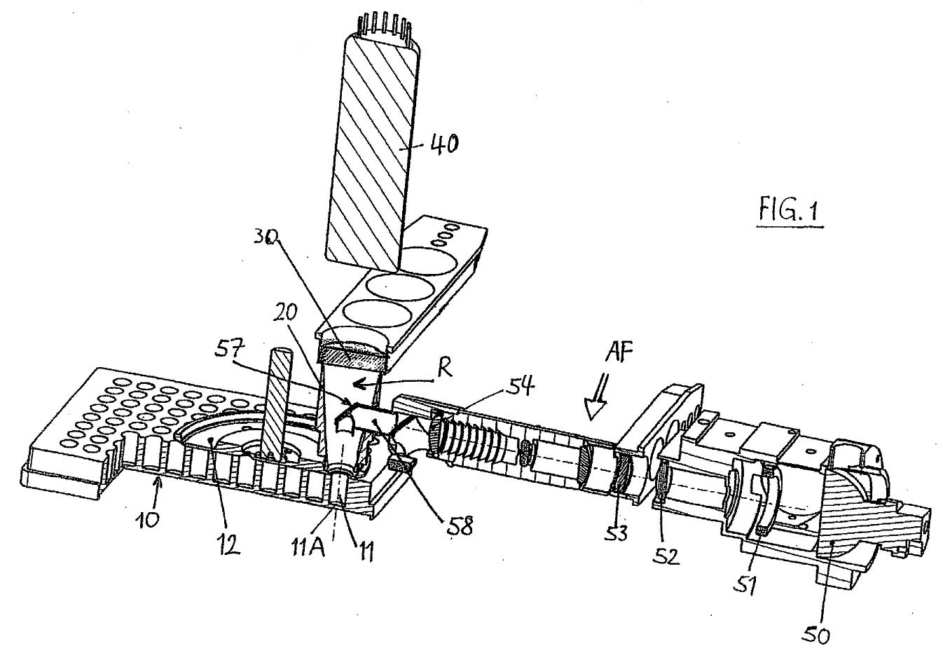

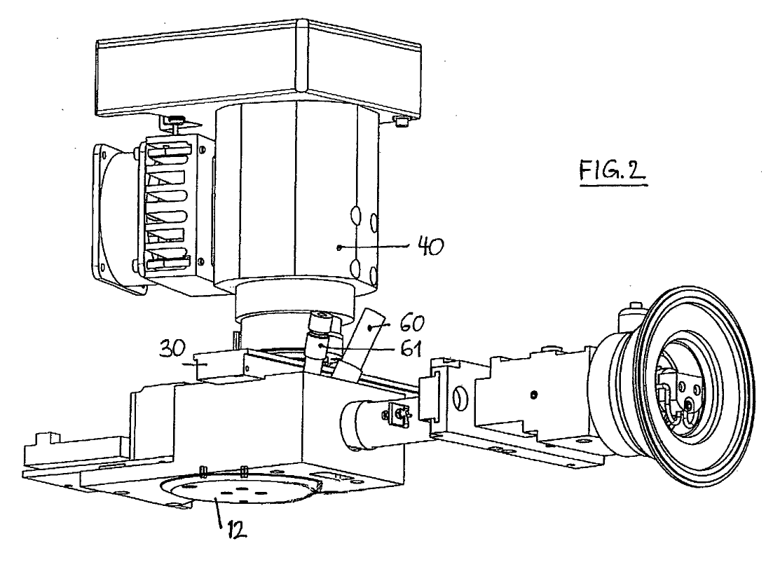

FIGS. 1 and 2 show the constructional design of the measuring apparatus; FIG. 1 with a microtiter plate 10, FIG. 2 without microtiter plate with an injection element and a laser module. The important components are as follows:

Disposed above the microtiter plate 10 with its sample wells 11 is a first reflector element 20, whose design will be described in detail further below. The top opening of this first reflector element 20 extends to an emission filter 30, above which a detector 40 for detecting the photons emitted from a sample well is disposed in a manner known per se. Leading from the sample well 11 to the detector 40, accordingly, is the emission light path EF of the emission radiation generated by the sample (not depicted) located in the sample well 11 by fluorescence or luminescence.

Supported between the first reflector element 20 and the microtiter plate 10 is an aperture wheel 12, whose design substantially corresponds to the European Patent Disclosure EP 1 279 964 A1 mentioned at the beginning and the disclosure of which is incorporated herein by reference, and which will therefore not be described in detail.

For measuring fluorescence, an excitation light path AF initially contains, in a manner known per se, a light source 50, an aperture 51, a lens 52 and an excitation filter 53. These components and their peripherals will not be described in detail here.

The excitation light enters into a tube 58 that is routed into a reflection chamber R formed by the first reflector element 20, where it is deflected such that it falls substantially perpendicularly onto the surface of the sample contained in the sample well 11. Serving this purpose is a second reflector element that is supported inside the tube 58; the design of this region will be described in detail further below.

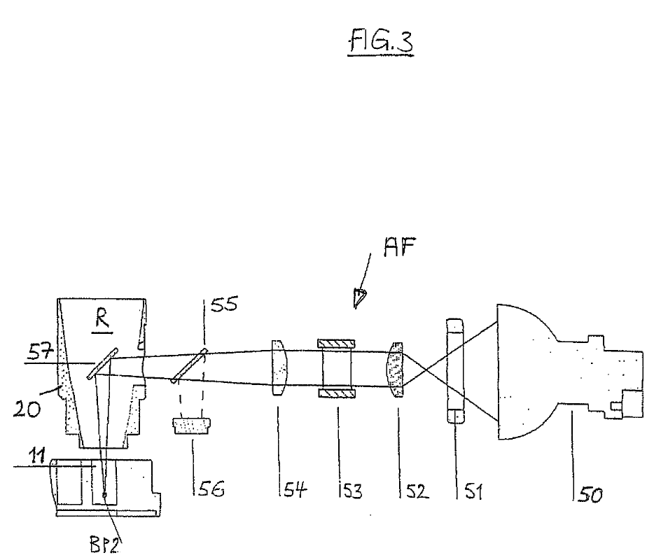

FIG. 3 schematically illustrates the beam path in the excitation light path AF with the optical components that create it, in this case with an additionally depicted reference unit consisting of a glass pane 55 and reference detector 56, which serves to regulate the light intensity.

A focusing lens 54 generates, from the light beam of the light source 50 that was collimated by the upstream optical elements, a weakly convergent light beam. The focusing effect of the focusing lens 54 is calculated such in this case that after the deflection of the light beam by the second reflector element the focal point BP2 of the excitation light beam comes to lie in the sample well 11. Because of the finite expanse of the light source 50 and unavoidable tolerances of the other optical components in the excitation light path AF, it is not possible to implement a mathematically exact focal point. The fluorescence excitation consequently takes place in the volume area of the sample that is located in the sample well 11 measured out by the excitation light.

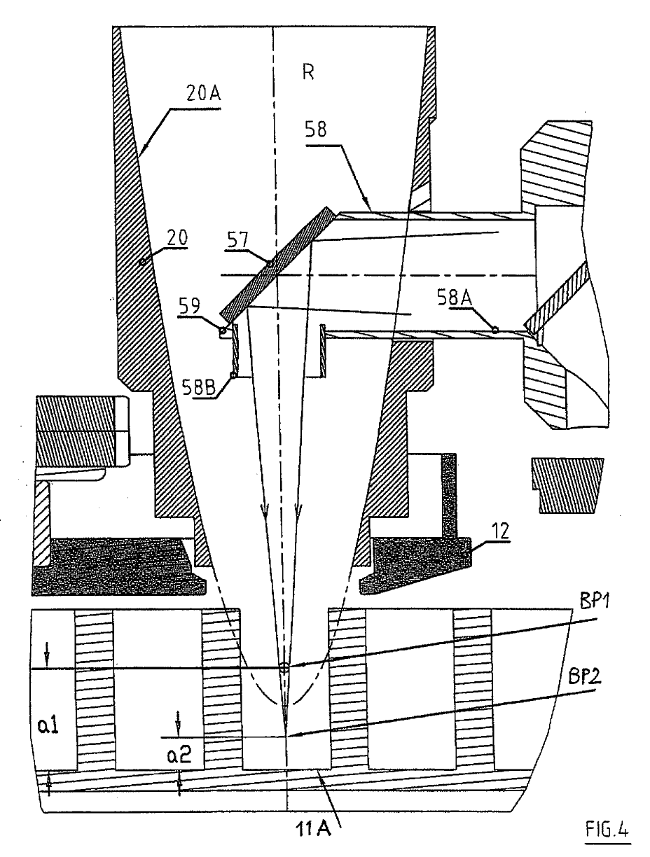

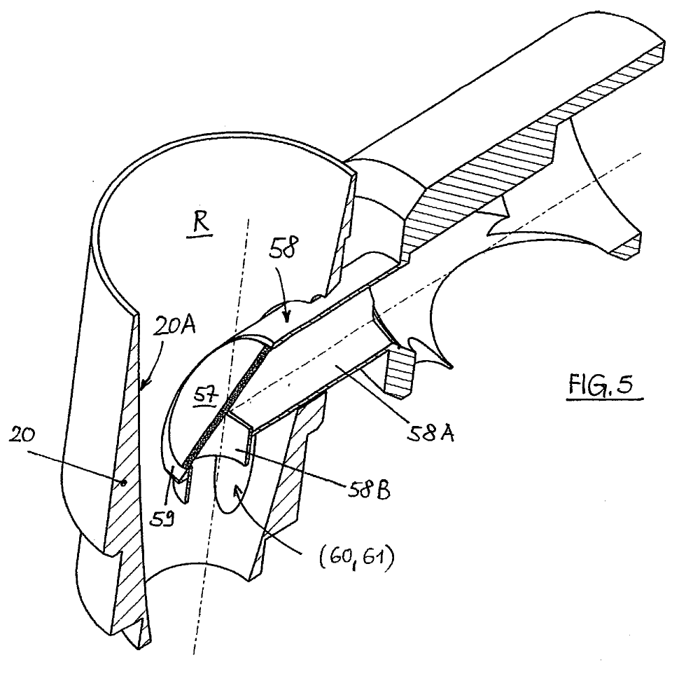

The components of this measuring apparatus that are characteristic to the invention, the reflector elements and their design and allocation, are shown in FIGS. 4 and 5.

The first reflector element 20 consists of a rotationally, or axially,-symmetrical component with a continuous channel that is disposed between the sample well 11 and emission filter 30. The interior wall 20A of this channel is reflective and has the shape of a frustum of a paraboloid of revolution, whose curve of intersection satisfies the parabolic equation y=n·x². The continuation of this curve of intersection to the “complete” parabola is depicted in FIG. 4 as a dashed line. This interior wall 20A forms the reflection chamber R. In practice, the factor n of the parabolic equation has a value between 3 and 5.

The focal point BP1 of this parabola and, therefore, of the mirrored interior wall 20A of the first reflector element 20, lies below the bottom opening of the reflector element 20 at a distance a1 from the bottom 11A of the sample well 11. Photons that are emitted in the region of the focal point BP1 from the sample are therefore (to the extent that they reach the interior wall 20A) oriented parallel in the reflection chamber R and therefore arrive substantially perpendicular on the surface of the emission filter 30.

The tube 58 that serves to guide the excitation light into the excitation light path AF (FIG. 5) comprises a first horizontal section 58A and, adjoining the same in an elbowed shape, a second section 58B whose longitudinal axis is coaxial to the longitudinal axis of the sample well 11.

Serving as the second reflector element is a flat mirror 57 that is disposed at an angle of 45° in each case to the longitudinal axis of the horizontal/vertical tube section 58A,58B, so that the excitation light is reflected from the first tube section 58A into the second tube section 58B. The depicted elliptical outline of the mirror 57 corresponds to the diameter of the tube sections and to the angle of 45°, so that the excitation light is presented with a circular mirror cross section.

As mentioned above, the focusing lens 54 effects a convergence of the excitation light beam in such a way that a second focal point BP2 is created that comes to lie at a second distance a2 from the bottom 11A of the sample well 11, also within the sample that is located there.

The difference between the distances a1 and a2, if commercially available microtiter plates 10 and the sample wells 11 contained therein are used, is within the range of approximately 2 mm.

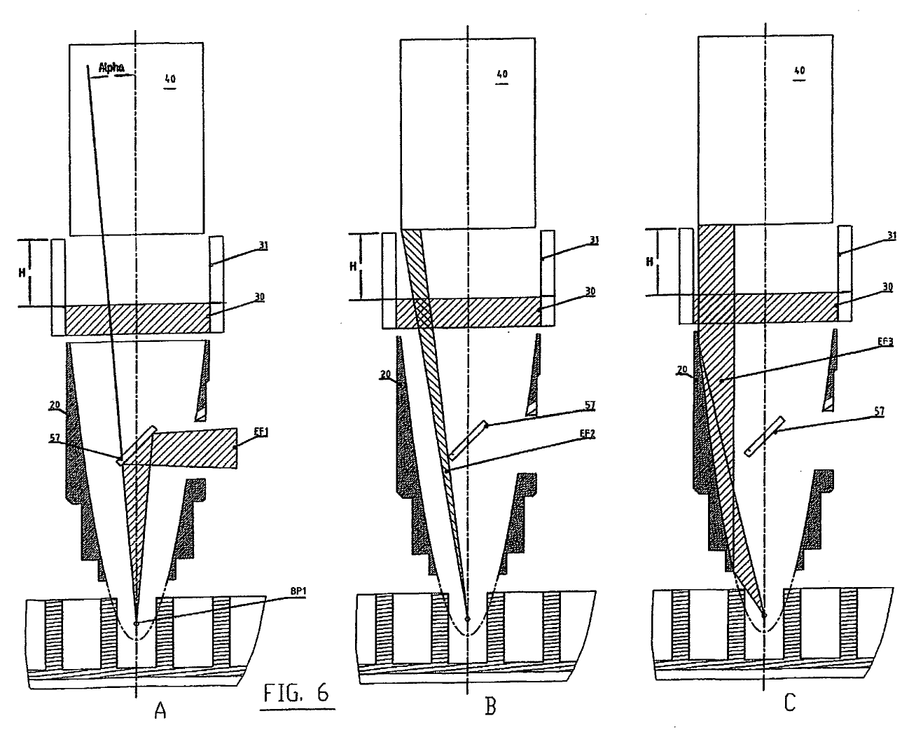

With the described mechanical and optical measures, an emission light path EF is obtained whose components are depicted in FIG. 6, proceeding in a simplified manner from emission light that starts at the focal point BP1:

A first portion EF1 (FIG. 6A) of the emission light cannot be used for the measurement in the detector 40. This includes beams that fall onto the mirror 57 and are reflected back into the excitation light path AF, but this portion also includes beams that fall onto the tube 58 and onto the support 59 of the mirror 57 and also cannot reach the detector 40 as these components are made light absorbing on their outside to prevent stray light.

A second portion EF2 (FIG. 6B) of the emission light passes the tube 58 and support 59 on one hand, but on the other hand also the interior wall 20A of the paraboloid section 20 and therefore falls directly at an angle that is definable via the size of these components and their distance relative to each other onto the emission filter 30 (FIG. 6B). In the presented preferred embodiment, approximately 10% of the emission light forms this second portion EF2.

If one wants to prevent this second portion EF2 of the emission light from reaching the detector, one can place above the emission filter 30 an absorption element in the form of a hollow cylinder 31 with a height H between the exit cross section of the emission filter 30 and the entrance cross section of the detector 40, whose inside is made light absorbing (e.g. by means of a coating of black felt). Alternatively, the diameter of the tube section 58B may be designed appropriately larger.

A third portion EF3 (FIG. 6C) of the emission light, lastly, falls onto the interior wall 20A of the paraboloid of revolution 20 and is accordingly (depending on its “origin” in the region of the focal point BP1) more or less precisely collimated and projected perpendicularly onto the emission filter 30; this portion amounts to approximately 90% of the emission light that falls onto the emission filter 30.

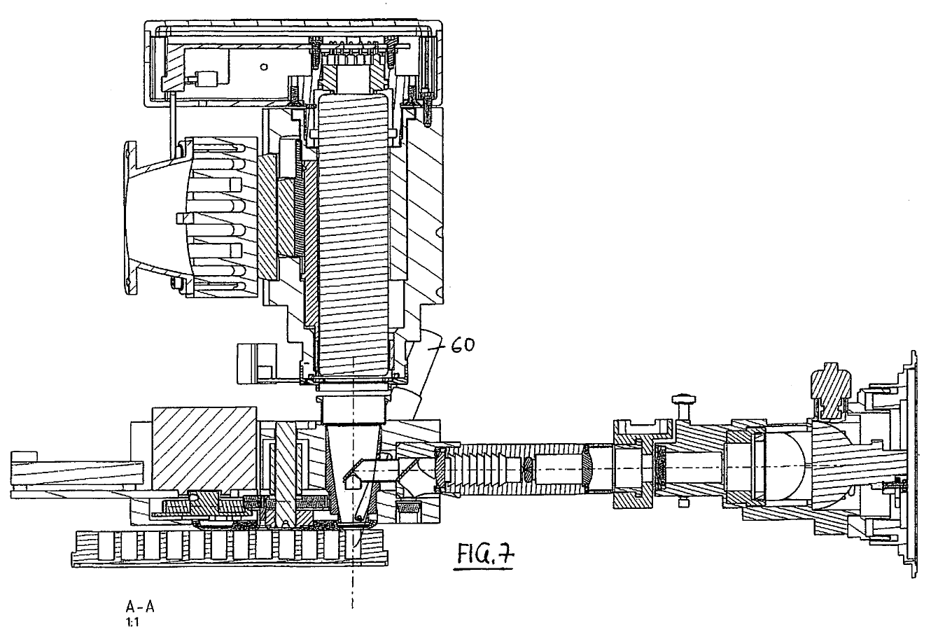

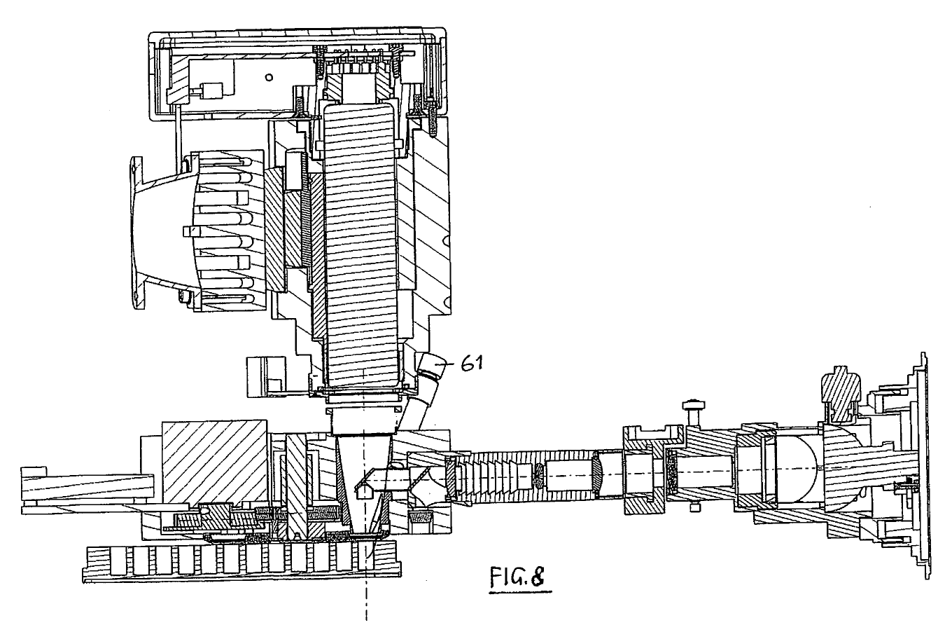

A laser module 60 and an injection element 61 are guided into the reflection chamber R and aimed into the sample well 11 (FIGS. 7 and 8).

If the optical components of the excitation light path AF are replaced with the laser module 60, a so-called alpha screen can be performed, in which the light of the laser is carried either directly or via an optical fiber that is disposed within a guide tube onto the sample. The irradiation takes place briefly in each case, then the light source is switched off and immediately afterwards the light is measured that is emitted from the sample.

The injection element 61 permits luminescence measurements in which the injection of reagents must take place in the measuring position.

In lieu of a laser module, provision may optionally be made for an additional injection element.

Without further embodiments the following measuring techniques can be carried out with the inventive measuring apparatus under achievement of the described advantages:

The FRET method differs from the standard fluorescence measurement in that the same sample is measured at two different emission wavelength ranges.

In the TRF method a pulsed light source, usually a xenon flash lamp, is used for the excitation. A series of flashes takes place for each measurement, after each flash the emission radiation is measured after an initial time delay within a certain time window. This eliminates interfering signals caused by fluorescence with a shorter decay time than that of the markings used with TRF.

The TR-FRET method is a combination of FRET and TRF in such a way such that TRF is measured for each sample at two different emission wavelengths.

For measuring absorption, a photodiode is located below the transparent bottom of a sample well. It is used to measure in a known manner the attenuation of the light arriving through the excitation light path during its vertical passage through the sample.

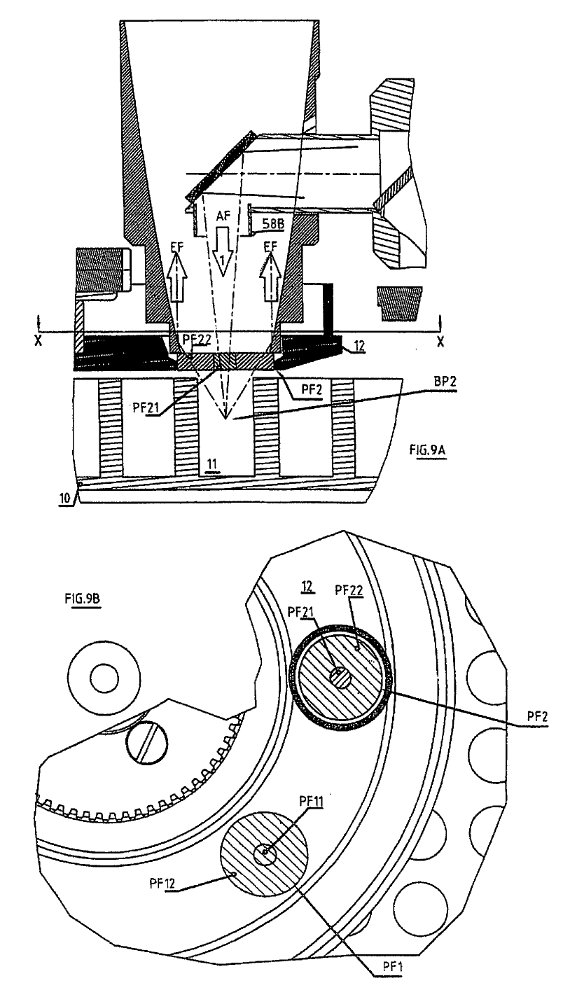

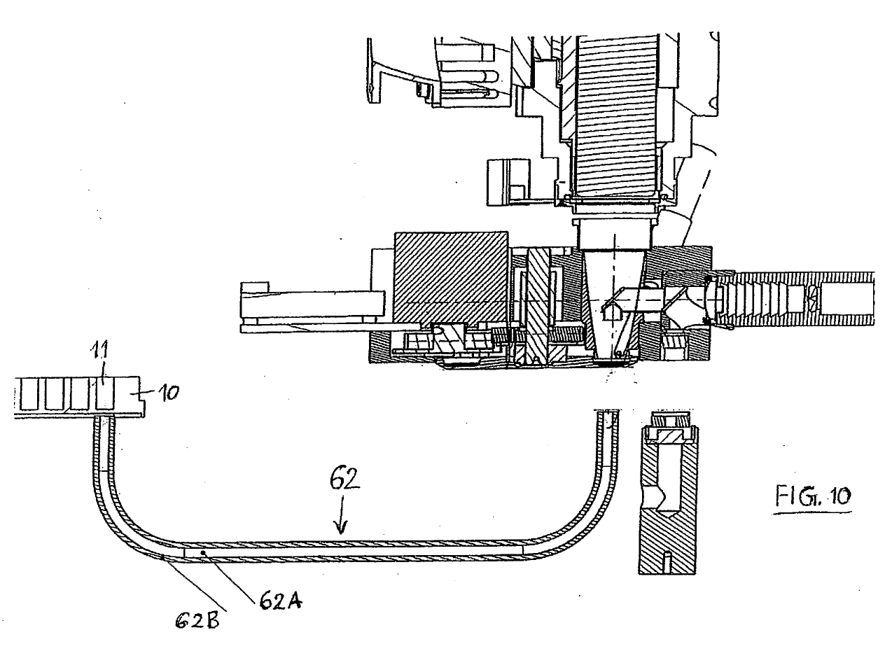

Additional applications and embodiments of the invention will now be described with reference to FIGS. 9 and 10:

In fluorescence polarization measurements the sample is irradiated by the light source with polarized light (excitation light path); in the emission light path those portions are determined that are on the one hand polarized parallel, and on the other hand perpendicular, to the polarization direction of the projected light of the light source.

This is achieved with the embodiment of the inventive measuring apparatus that is schematically depicted in FIG. 9:

Disposed immediately above the sample is one of two polarization filter arrangements PF1, PF2, which are positioned one after the other over the sample and centered relative to the optical axis of the emission light path EP.

The polarization filter arrangements PF1, PF2 in the depicted exemplary embodiment are housed in terms of construction on the same aperture wheel 12 on which the various apertures are disposed also.

Disposed in the respective center of each of these two polarization filter arrangements PF1, PF2, is a first, circular polarization filter PF11, PF21, encompassed by a second, ring-shaped polarization filter PF12, PF22.

In the first filter arrangement PF1 the polarization direction of the two polarization filters PF11, PF12 is parallel in the inner circle region and outer ring-shaped region; in the second filter arrangement PF2 the polarization direction of the two polarization filters PF21, PF22 is perpendicular to each other (the hatching in FIG. 9B represents the polarization directions).

In the position shown in FIG. 9A of the aperture wheel 12 the second polarization filter arrangement PF2 is located in the beam path.

An adaptation of the dimensioning of the above-described optical components in the excitation light path AF to the diameter of the first polarization filters PF11, PF21 is made in such a way that the excitation radiation (downward arrow) enters into the sample only through the first polarization filter PF11, PF21, and that in the emission light path EP only that portion of the exiting emission light is measured (upward arrow) that exits through the second polarization filter PF12, PF22. The latter is also achieved by means of the shielding that is effected by the vertical section 58B of the tube 58, which blocks the undesirable radiation that exits through the first polarization filters PF11, PF21 from reaching the emission filter 30 and detector 40.

To measure a sample, the two polarization filter arrangements PF1, PF2, are moved one after the other into the measuring position over the sample; the ratio of the intensities measured in the process yields a measure of the polarization or depolarization, respectively.

An additional advantageous embodiment of the inventive apparatus (FIG. 10) serves to perform fluorescence measurements from below, which are performed with certain samples, e.g. cells that adhere to the bottom of a microplate, through the transparent bottom of a microplate 10.

The excitation light path AP corresponds to the one described above for fluorescence measurements, however, here the light does not fall directly onto sample but it first enters into an optical fiber 62.

The optical fiber 62 consists of an inner optical fiber bundle 62A, which represents the continuation of the excitation light path AF to the sample well 11, and of an outer optical fiber bundle 62B that encompasses the optical fiber bundle 62A.

From the exit end of the optical fiber bundle 62A the light is projected from below into the sample well 11. The fluorescent light that is generated in the sample enters, to the extent that it is directed downward, into the optical fiber 62 and then passes through the reflection chamber 20 in order to ultimately fall onto the emission filter 30 and the detector 40.

In this arrangement the sample is laterally offset from the optical axis of the emission light path EP in the reflection chamber R.

The optical fiber 62 can be moved by motor into a non-active position, to create room for a standard florescence measurement of a microplate from above.

An additional embodiment of the invention relates to the region between the top exit opening of the first reflector element, which may be implemented e.g. as a paraboloid of revolution, and the detector.

It has already been described that a portion denoted with EF2 of the emission light (FIG. 6B) does not fall parallel onto the emission filter in the desired manner. To eliminate this portion, which in fluorescence measurements leads to an increase in interfering signals, an absorption element in the form of a hollow cylinder, whose inner surfaces are made light absorbing, may be disposed as already described between the emission filter and detector.

This configuration, however, is advantageous only for fluorescence measurement, whereas in measurements of bioluminescence and chemiluminescence the radiation portion EF2 is part of the effective radiation and must therefore not be absorbed.

In certain types of fluorescence measurements, in particular TR-FRET, it has proven advantageous to provide above the emission filter a lens that guides the emission light convergingly toward the detector and under certain circumstances focuses it on the region of the detector entrance surface. Depending on the measuring task at hand, various entrance apertures are then placed upstream of the detector in addition.

In accordance with the invention, disposed between the top exit opening of the first reflector and the detector are exchangeable modules, which can be moved into the optical path in accordance with the measuring objective.

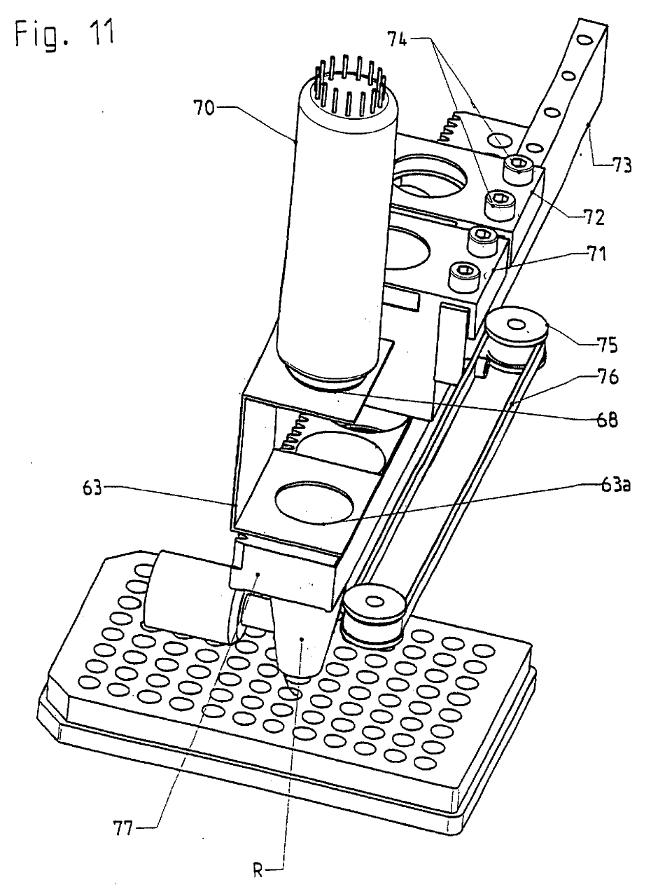

A preferred embodiment is shown in FIG. 11. In a flat-lying U-shaped yoke are two openings. The first opening 63a permits the light to enter from the reflection chamber R, the other is the exit opening 68 to the detector 70. Into the space that is bordered by the U-shaped yoke the respective selected module is positioned. The individual modules, e.g. 71 and 72, are mounted on a support rail 73, where they are secured with two screws 74. The rail with the attached modules, in turn, is secured to a linear guide means (not shown).

By means of a motor (not shown), a toothed belt 76 to which the support rail is coupled is moved via a drive wheel 75.

Disposed between the exit opening from the reflection chamber and the entrance opening into the U-shaped yoke is the filter slide 77.

The support rail is oriented such that each module that is mounted on it can be moved into the required position in the emission light path.

The support rail can, with the aid of its drive, move the modules out of the instrument after opening of a light-impermeable door flap, so that the user can change or examine the mounted modules. For identification purposes the modules may be provided with a barcode label or with a radio frequency identification (RFID) module.

In the simplest case, the instrument is equipped with only one optical module.

The modules and transport mechanism are constructed such that different modules can be moved into the emission light path quickly, i.e. in under 0.5 seconds. This permits the same sample or same microplate to be measured with different optical methods.

All modules have identical outer dimensions and the outer shape of cuboids, to which identical parts for securing the modules to the rails are added, so that they are easy to exchange.

The design of individual modules will be described in detail below.

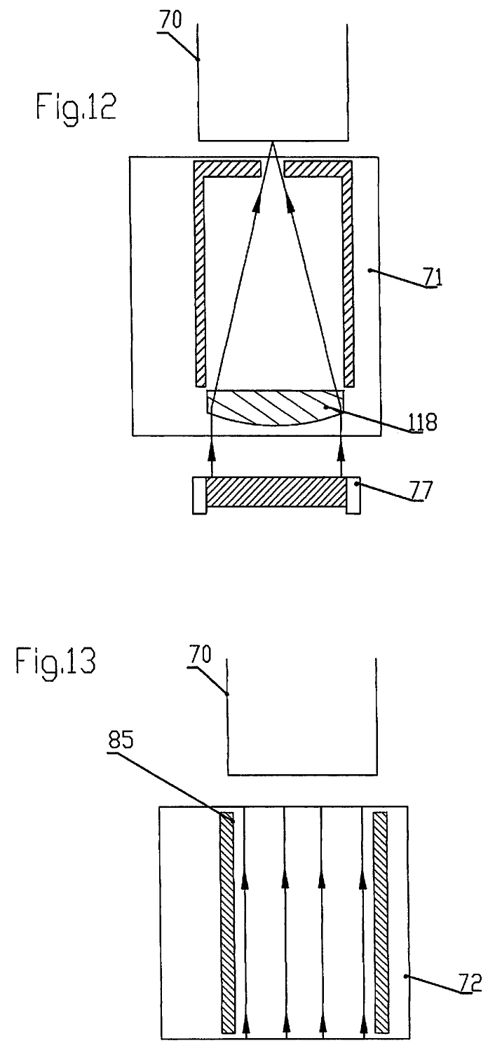

FIG. 12 shows a module for measuring both the current as well as the time-resolved fluorescence. A suitable filter is selected to this effect in the filter slide 77. A lens in the module focuses the light onto the sensitive part of the detector.

It has been shown that the optimal diameter of the aperture upstream of the detector varies depending on the application. Different modules are therefore provided, each with a different aperture shape.

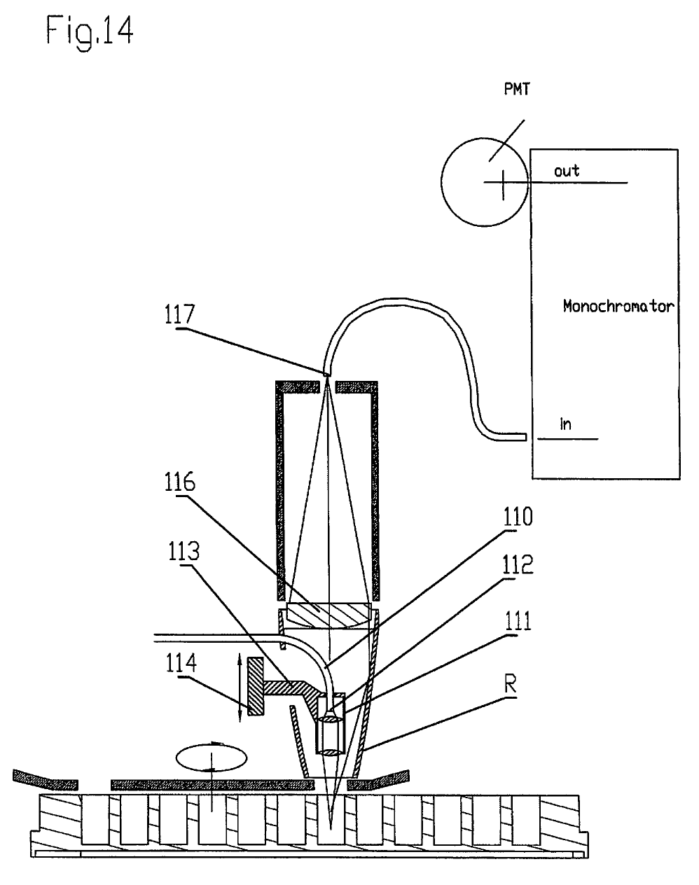

FIG. 13 shows a module for standard luminescence measurements without filter and having only a tube length 85 with mirrored interior so that as much light as possible is carried to the detector.

As long as the optical part of the individual modules remains substantially unchanged, the various optical constructions, which shall be termed intermediate optics, can also be housed in a single, i.e. non-modular slide or wheel, as a cost-effective alternative. This slide runs above the filter slide and permits any desired combination of optical filter and intermediate optics.

The inventive instrument design with modules differs in significant aspects from other known concepts. In U.S. Pat. No. 6,891,681 B2, according to FIG. 2, the excitation light is fed via an optical fiber through an aperture into the module and falls onto a dichroic mirror that deflects the light via two lenses that are positioned outside the module onto the sample. The fluorescent light that is generated in the sample is directed back via the two lenses onto the dichroic mirror, through which the longer-wave light passes, and is carried onto a dichroic beam splitter.

That splitter splits the light into two wavelength ranges. Each of the partial beams that is formed in this manner leaves the module through an additional aperture in each case, in order to ultimately be measured separately via two filters and corresponding lenses in two detectors.

In the first place, this optical system has the crucial shortcoming that the two dichroic mirrors or beam splitters are impinged upon only by either convergent or divergent light beams, whereas the best performance is attained only with parallel light incidence.

Another significant shortcoming of this optical system is that it is not suitable for the sensitive measurement of chemiluminescence. These measurements require an optional detector 323c, 331c, that receives the light via an optical fiber directly from the sample. Even then it is apparently not possible to inject reagents into the measuring position; nor is it possible in this configuration to perform chemiluminescence measurements with filters, such as BRET or Chroma-Glow.

The configuration according to the invention eliminates these shortcomings and has added advantages beyond this.

First, the mirror that directs the excitation light to the sample is not part of a module, because a universally useable configuration was found with the invention that does not need to be modified in each case based on the selected measuring principle. Consequently, these functions do not need to be contained again in each module, which makes them simpler, smaller and less expensive.

Because of the high optical efficiency of the reflection chamber, chemiluminescence can be measured with the same optical system and the same detector as in fluorescence measurements, and with the highest sensitivity at that.

Injecting reagents into the measuring position is possible, and wavelength-dependent chemiluminescence measurements can take place by introducing filters into the optical path.

Since the radiation does not enter into the module through apertures, the mechanical adjustment becomes less critical as well, which is important in the case of exchangeable modules.

The inventive design also does not use apertures that are disposed on the module to adjust the diameter of the light beam that falls onto the sample, as this purpose is served by the aperture wheel 12 that is disposed directly above the sample and that contains apertures of different diameters and shapes.

To achieve maximum flexibility in the selection of the wavelengths to be measured, instruments can also be equipped with monochromators. With these it is possible to select the desired wavelengths over wide spectral ranges. To optimally suppress undesirable wavelengths, double monochromators are used, one of which is located in the excitation light path and another in the emission light path.

However, monochromators also have drawbacks when compared to filters, as they lead to noticeably lower detection sensitivities in multi-label readers in some spectral ranges. For this reason it is desired that measurements can optionally be performed either with filters or with monochromators in a single instrument, and switching between the two operating modes needs to be as simple as possible.

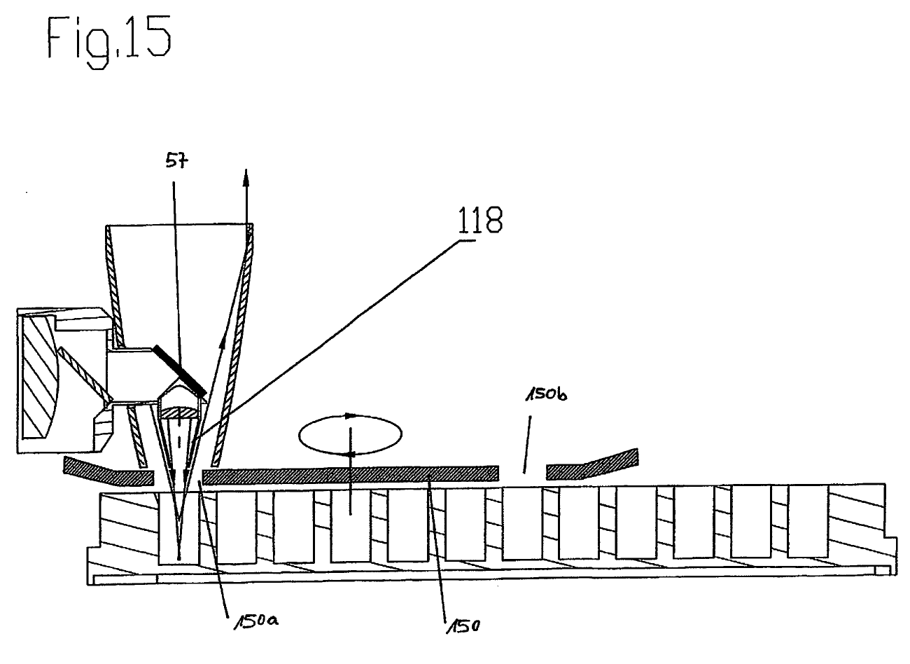

For measurements with monochromators, the configuration shown in FIG. 14, with an optical fiber 110 and emission head 111, is suitable to carry the light. The end of the optical fiber 112 is fixed in a socket. The exiting divergent light is focused by means of one or two lenses, as shown, that are also fixed in the emitter head onto a focal point that lies, e.g. in the sample. The emitter head is connected via a connecting element 113 to a support means 114. In a further embodiment of the invention the support means and accordingly also the emitter head can be moved in the axis of the reflection chamber and into different positions, thereby causing the focal point to change in the same manner. This permits an adaptation to different formats and degrees of filling of microplates.

Also, an entirely different focal point position is required for measuring the light absorption with a detector that is positioned below the transparent bottom of a microplate than in a fluorescence measurement.

The focal point may also be positioned above the sample, so that a divergent light bundle is created below it. This may be desirable in order to irradiate the entire bottom surface of a sample well with excitation light.

Carrying the excitation light into the reflection chamber by means of an optical fiber is expedient if a monochromator is used in the excitation path and the optical fiber carries the light directly from the exit of the monochromator into the emitter head. With an appropriate arrangement of the fibers, the optical fiber can, at the same time, serve to convert the rectangular profile of the light at the exit slit of the monochromator into a round profile at the end of the optical fiber in the emitter head.

If, on the other hand, the light in the emission path is to be routed to a monochromator, it is advantageous to design the reflection chamber as part of a rotation ellipsoid that is mirrored on the inside, which focuses the radiation emitted by the sample onto an optical fiber.

The reflection chamber can also be a paraboloid of revolution, with the substantially parallel light that exits from the top opening being focused by means of a lens (116) onto the entrance cross section of the optical fiber (117).

This optical fiber may have at its entrance a round cross section and at its exit, that is upstream of the entrance slit, a rectangular cross section that corresponds to the entrance slit of the emission monochromator.

The configuration with optical fiber and emitter head as it is described here is not limited to the use of monochromators. The optical fiber in the excitation path can also carry the light, after passage through filters and appropriate focusing onto its entrance cross section-which could be round in this case-into the reflection chamber.

In an additional embodiment of the invention the excitation light is carried completely shielded toward the outside to a point immediately above the sample. A number of possible implementations exist for this:

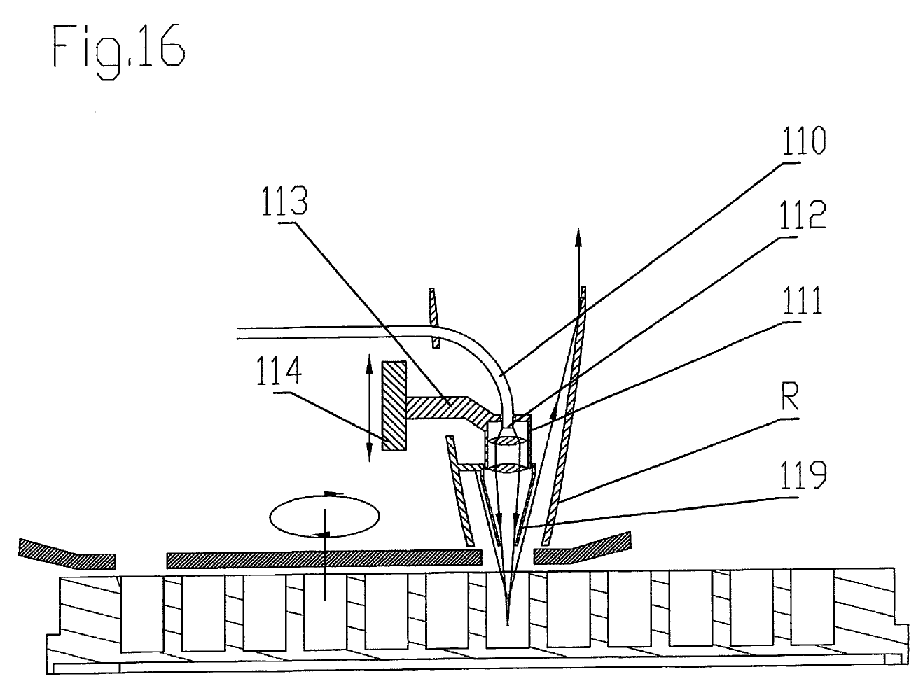

FIG. 15 shows a first embodiment. Using a shielded deflecting mirror 57, the lateral shielding of the excitation light is continued between the deflecting mirror 57 and the sample, the shielding being substantially in the form of a tube 118 that narrows toward the bottom in order to lose as little emission light as possible. At a short distance above the sample, there may also be disposed a focusing lens, to achieve a particularly narrow excitation beam of less than 1 mm diameter.

If the excitation light is carried to the sample through an optical fiber, a downwardly tapered shielding tube 119 may extend, as shown in FIG. 16, from the lens that is disposed directly over the sample to a point immediately above the sample.

In both versions the light exit opening that is located above the sample at the same time represents an aperture in which provision is made that the scattered radiation that accumulates on the inside cannot enter into the emission beam path and cause an increase in background radiation. The inner and outer surface of the tube 118 and shielding tube 119, respectively, are advantageously made light absorbing.

The region of the shielding between the lens located above the sample and the sample may be made modular; and various aperture components with different exit openings 150a, 150b or different optical components located on a slide or disc 150 can be exchanged with one another. One example is a configuration for measuring fluorescence polarization. It is a variant of the previously described configuration shown in FIG. 9, such that the entire excitation light path is shielded up to the central circular polarization filter. With the aid of the slide or disc, the two filter arrangements are moved into position one after the other.

In a number of measuring methods, such as e.g. BRET, FRET, or TR-FRET, it is necessary that the intensity of the emitted light is measured from the same sample in two different wavelength ranges. Customarily this is done by taking two consecutive measurements with different optical filters.

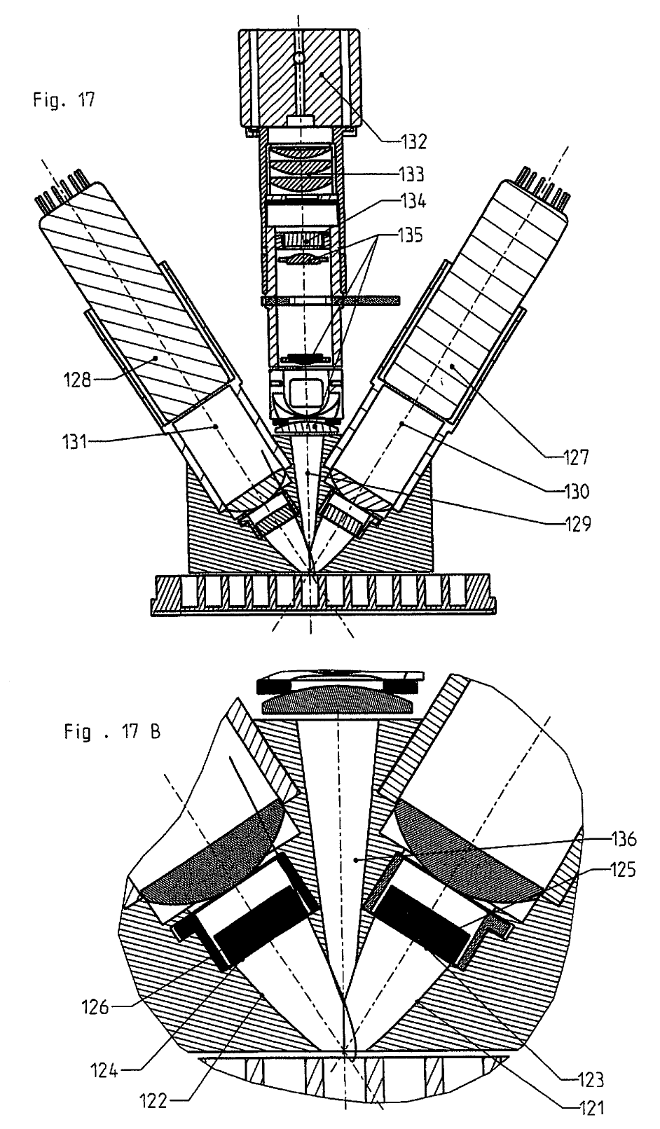

FIGS. 17 and 17B show a further embodiment of the invention that is suitable particularly for use with BRET, FRET or TR-FRET. To attain a faster sample throughput and, in many cases, greater accuracy, it is desirable that the intensity measurements in the two wavelength ranges take place simultaneously. For this purpose the inventive reflection chamber is implemented such that two detectors simultaneously can detect the light that is emitted by the sample, and each of the detectors can be assigned a different optical filter. In the embodiment shown in FIGS. 17 and 17B the reflection chamber is constructed as a twin chamber with two partial areas 121, 122. In each partial area there is an opening 123, 124 for the light exit to the filter 125, 126 and detector 127, 128.

In addition to the optical main axis 129, which extends vertically through the sample, two secondary axes 130,131 are formed in this case that extend from the sample in each case through the center of the respective filter and that are perpendicular to them, so that all three axes meet in the region of the sample. Each of the two partial areas may have the shape e.g. of a paraboloid of revolution about the respective secondary axis, with the two paraboloids partially overlapping. The angle of inclination of the secondary axes relative to the main axis is to be less than 45°.

The filters that are situated between the top exit opening of each paraboloid and the respective detector are mounted on a filter slide or filter wheel, so that different filters or also vacant positions can be switched against each other at any time.

The excitation light path starts at the upper portion of the optical main axis 129 with the light source 132, so that the light is guided from the top down to the sample. Via a first lens construction 133 the light is first collimated, then passes through an excitation filter 134 and is lastly focused through a lens (135) or multiple lenses onto the region of the sample. To prevent stray light, the excitation light travels the longest possible length of its path inside a shielding tube 136.

The excitation light may also come from a monochromator in the excitation path; in this case a suitable configuration is that of an optical fiber combined with focusing lenses as shown in FIG. 16.

The detectors may be disposed either directly behind the emission filters, or additional optical components, such as e.g. reflectors, lenses or apertures, are positioned between the filter and detectors.

For standard luminescence measurements in which no filters are needed the signals of the two detectors may be added to achieve maximum sensitivity. If the two detectors are fast photon counters they may be operated also with a coincidence circuit, in order to permit, as scintillation counters, radioactivity measurements with the highest sensitivity. This application relates to subject matter disclosed in German Utility Model Applications 20 2007 017 895.6, filed on Dec. 21, 2007 and 20 2008 009 859.9, filed on Jul. 23, 2008, the disclosures of which are incorporated herein by reference.

The foregoing description of the specific embodiments will so fully reveal the general nature of the invention that others can, by applying current knowledge, readily modify and/or adapt for various applications such specific embodiments without undue experimentation and without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. The means, materials, and steps for carrying out various disclosed functions may take a variety of alternative forms without departing from the invention.

Thus the expressions “means to . . . ” and “means for . . . ”, or any method step language, as may be found in the specification above and/or in the claims below, followed by a functional statement, are intended to define and cover whatever structural, physical, chemical or electrical element or structure, or whatever method step, which may now or in the future exist which carries out the recited function, whether or not precisely equivalent to the embodiment or embodiments disclosed in the specification above, i.e., other means or steps for carrying out the same functions can be used; and it is intended that such expressions be given their broadest interpretation.

### REFERENCE SYMBOLS

AF excitation light path
EF emission light path
R reflection chamber
10 microtiter plate
11 sample well
12 aperture wheel
20,21 first reflector element
20A,21A interior wall
BP1, BP2, BP3 focal points
30 emission filter
31 hollow cylinder
40 detector
50 light source
51 aperture
52 lens
53 excitation filter
54 focusing lens
a1 first distance
a2 second distance
55 mirror
56 reference detector
57 deflecting mirror
58 tube
58A horizontal section
58B vertical section
59 support
60 laser module
61 injection element
62 optical fiber
62A inner optical fiber bundle
62B outer optical fiber bundle
63 U-shaped yoke
63a first opening
70 detector
71,72 module
73 support rail
74 screw
75 drive wheel
76 toothed belt
77 filter slide
110 optical fiber
111 emitter head
112 end of the optical fiber
113 connecting element
114 support means
116 lens
118 tube
119 shielding tube
121,122 partial area of the reflection chamber
123,124 opening
125,126 filter
127,128 detector
129 main axis
130,131 secondary axis
150 disc
150a, 150b exit opening

What is claimed is

1. An apparatus for selected measurement of at least one of luminescent and fluorescent radiation from at least one sample well, said apparatus comprising: means defining an excitation light path for fluorescence measurements; at least one light source in said excitation path; means defining an emission light path; and at least one detector with a wavelength selector in said emission light path, wherein: said apparatus further comprises at least one first reflector element that encompasses a reflection chamber and projects at least a portion of the light emitted from the at least one sample well directionally onto said wavelength selector; said emission light path extends between the at least one sample well and said wavelength selector through said at least one first reflector element; and said excitation light path extends into said reflection chamber and extends to a point above the at least one sample well.

2. The apparatus according to claim 1, wherein said wavelength selector is an emission filter.

3. The apparatus according to claim 2, wherein said reflection chamber of said first reflector element has a mirrored interior wall that has the shape of a section of a paraboloid of revolution with a curve of intersection conforming to the equation
y=n·x^{2,}
wherein said section extends substantially from the at least one sample well to said emission filter.

4. The apparatus of claim 3, wherein the focal point of said paraboloid of revolution comes to lie within the at least one sample well.

5. The apparatus according to claim 3, wherein the focal point of the paraboloid of revolution comes to lie at a first distance from the bottom of the at least one sample well.

6. The apparatus according to claim 5, further comprising a focusing lens disposed in said excitation light path, said focusing lens having a focal point that is located at a second distance from the bottom of the at least one sample well and within the at least one sample well, wherein the first distance is greater than the second distance.

7. The apparatus according to 6, wherein when commercially available microtiter plates are used as the at least one sample well, the difference between the first and second distances is approximately 2 mm.

8. The apparatus according to claim 3, wherein the value of n is between 3 and 5.

9. The apparatus according to claim 2, wherein said reflection chamber is formed by an interior wall of adjoining cone frustums that substantially extend from the at least one sample well to said emission filter and the curves of intersection of the cone frustums approximate the curve of intersection of a paraboloid of revolution.

10. The apparatus of claim 9, wherein the focal point of the curves of intersection comes to lie within the at least one sample well.

11. The apparatus according to claim 1, further comprising a second reflector element contained in said excitation light path and in said reflection chamber for guiding excitation light substantially perpendicular onto the surface of a sample in the at least one sample well.

12. The apparatus according to claim 1, further comprising a tube having a light absorbing surface, said tube being disposed within said reflection chamber and forming a light-impermeable portion of said excitation light path.

13. The apparatus according to claim 12, wherein: said reflection chamber has a mirrored interior wall that has the shape of a section of a paraboloid of revolution; and said tube has an upper section and a lower, vertical section, said sections being angled relative to each other to form a 90° angle between said sections in said reflection chamber.

14. The apparatus of claim 13, wherein said lower, vertical section has a longitudinal axis that comes to lie in the axis of the section of a paraboloid of revolution.

15. The apparatus according to claim 13, further comprising a second reflector element contained in said excitation light path and in said reflection chamber for guiding excitation light substantially perpendicular onto the surface of a sample in the at least one sample well, and wherein said second reflector element is a flat deflecting mirror that is positioned inside said tube in such a way that said mirror reflects excitation light from said upper section into said lower section of said tube, and said upper section is horizontal.

16. The apparatus according to claim 10, wherein said tube has an upper section and a lower, vertical section, said sections being angled relative to each other to form a 90° angle between said sections in said reflection chamber, said lower section of said tube is disposed in said reflection chamber and dimensioned in such a way that its light absorbing surface absorbs emission light that is emitted from the at least one sample well at an undesirable angle range (alpha).

17. The apparatus according to claim 1, further comprising a focusing lens disposed in said excitation light path.

18. The apparatus according to claim 17, wherein said focusing lens has a focal point that is located at a second distance from the bottom of the at least one sample well and within the at least one sample well.

19. The apparatus according to claim 1, wherein said first reflector element ends at a distance from said detector (40).

20. The apparatus according to claim 19, wherein: said wavelength selector is an emission filter; said reflection chamber of said first reflector element has an interior wall that has the shape of a section of a paraboloid of revolution; and said apparatus further comprises a hollow cylinder disposed between said emission filter and said detector, said hollow cylinder having an interior wall that absorbs emission radiation that does not fall onto the interior wall of said paraboloid of revolution and therefore does not travel perpendicularly to said emission filter.

21. The apparatus according to claim 20, wherein said interior wall of the hollow cylinder consists of black felt, or has multi-reflecting grooves.

22. The apparatus according to claim 20, wherein the height of said hollow cylinder is 10 to 20 mm.

23. The apparatus according to claim 1, further comprising, in said first reflector element, at least one of: a laser module oriented for emitting light into a sample in the at least one sample well; and at least one injection element oriented for introducing reagents into a sample in the at least one sample well.

24. The apparatus according to claim 1, wherein: said reflection chamber has a lower end; and said apparatus further comprises support means for optical elements rotatably or slideably mounted between the lower end of said reflection chamber and the at least one sample well.

25. The apparatus according to claim 24, further comprising optical elements that include at least two polarization filter arrangements adapted to be carried by said support means.

26. The apparatus according to claim 25, wherein said support means is an aperture wheel, having various apertures, including at least one aperture for accommodating said polarization filter arrangements, such that a selected optical element can be moved into the emission light path.

27. The apparatus according to claim 26, wherein each of said polarization filter arrangements has a center and comprises: a first, circular polarization filter at said center; and a second ring-shaped polarization filter surrounding said first polarization filter, wherein said polarization filters of a first polarization filter arrangement have parallel the polarization directions, and said polarization filters of a second polarization filter arrangement are perpendicular to each other.

28. The apparatus according to claim 27, wherein said means defining an excitation light path and the dimensions of said polarization filters are adapted to each other in such a way that excitation radiation enters into a sample in the at least one sample well only through said first polarization filters, and in the emission light path only the emitted light that passes through said second polarization filters reaches said detector.

29. The apparatus according to claim 1, wherein: said reflection chamber has a lower end; the at least one sample well has a transparent bottom; and said apparatus further comprises an optical fiber disposed between said lower end of said reflection chamber and the transparent bottom of the at least one sample well, for guiding excitation light and emission light.

30. The apparatus according to claim 29, wherein said optical fiber comprises an inner optical fiber bundle and an outer optical fiber bundle surrounding said inner optical fiber bundle.

31. The apparatus according to claim 1, wherein said at least one detector comprises at least two detectors each having at least one entrance window and said detectors are disposed beyond said reflection chamber.

32. The apparatus according to claim 31, wherein said reflection chamber has two partial areas.

33. The apparatus according to claim 32, wherein said partial areas each have a paraboloid form.

34. The apparatus according to claim 31, wherein each of said entrance windows has a surface normal, or secondary axis, that is oriented obliquely to the surface of a sample in the at least one sample well.

35. The apparatus according to claim 34, wherein the excitation light path extends between said two detectors and is substantially perpendicular to the surface of the sample so that excitation light is not deflected in said reflection chamber.

36. The apparatus according to claim 1, wherein: said at least one detector has an entrance window; said reflection chamber has an exit opening; a space is provided between said entrance window of said detector and said exit opening of said reflection chamber; and said apparatus further comprises at least one module in said space, said module having an entrance opening and at least one exit opening, said module being disposed to provide a light-impermeable connection between said exit opening of said reflection chamber and said entrance window of said detector.

37. The apparatus according to claim 36, wherein said at least one module comprises at least two modules that are movable alternatively into said space between said entrance window of said detector and said exit opening of said reflection chamber.

38. The apparatus according to claim 37, wherein at least one of said modules is supported on a movable support rail.

39. The apparatus according to claim 38, wherein both of said modules are supported on the support rail so as to be exchangeable.

40. The apparatus according to claim 36, wherein said apparatus further comprises a flat-lying U-shaped yoke having an upper leg and a lower leg opposite to said upper leg; said at least one detector is supported on said upper leg; said lower leg is connected to said at least one first reflector element, wherein upper leg and said lower leg each have an opening; and each said opening is associated with a respective one of said entrance window of said detector and said exit opening of said reflection chamber.

41. The apparatus according to claim 1, wherein said apparatus further comprises an optical fiber for conducting excitation light into said reflection chamber.

42. The apparatus according to claim 41, wherein: said apparatus further comprises an emitter head in said reflection chamber; and said optical fiber has an end that is supported on said emitter head.

43. The apparatus according to claim 42, wherein said emitter head is disposed so as to be axially movable toward the at least one sample well.

44. The apparatus according to 43, wherein said emitter head additionally carries at least one lens.

45. The apparatus according to 42, wherein said emitter head additionally carries at least one lens.

46. The apparatus according to claim 42, wherein said apparatus further comprises a shielding tube that extends from said emitter head and that conically narrows toward the at least one sample well.

47. The apparatus according to claim 41, further comprising a monochromator disposed in the excitation light path and having an exit, and wherein said optical fiber has an entrance end disposed to receive light directly from said exit of said monochromator.

48. The apparatus according to claim 1, further comprising a monochromator to which emission light exiting from said reflection chamber is guided.

49. The apparatus according to claim 48, further comprising an optical fiber via which the emission light is guided to said monochromator.

50. The apparatus according to claim 49, wherein: said optical fiber has an entrance cross section; and said apparatus further comprises a collecting lens disposed between said reflection chamber and said optical fiber to focus light onto said entrance cross section of said optical fiber.

51. The apparatus according to claim 1, further comprising a monochromator disposed in said excitation light path.

52. The apparatus according to claim 1, further comprising a first monochromator to which emission light exiting from said reflection chamber is guided and a second monochromator disposed in said excitation light path, and wherein each of said monochromators is a double monochromator.
